(19) United States
(12) Patent Application Publication
(10) Pub. No.: US 2012/0117486 A1
(43) Pub. Date: May 10, 2012

(54) Method and Apparatus for Web Page Glancing

(75) Inventors: Darin Myman, Howell, NJ (US); Douglas W. Walsh, Monmouth Junction, NJ (US); Peter Shelus, South Plainfield, NJ (US)

(73) Assignee: PeopleString, Red Bank, NJ (US)

(21) Appl. No.: 12/943,760

(22) Filed: Nov. 10, 2010

(51) Int. Cl. G06F 3/01

(52) U.S. Cl. 715/745

(57) ABSTRACT

A method and a system for a personalized web page display an image that captures at least part of a targeted web page. The image of the at least part of the targeted web page displayed on the personalized web page is updated by creating an updated image of the targeted web page, storing the updated image on a server and inserting the updated image in the personalized web page. The lay-out of the personalized web page, including selecting a targeted web page and determining a position and a size of the updated image of the at least part of the targeted web page on the personalized web page is determined during a design phase. The personalized web page including the updated image is displayed during an operational phase. During the operational phase an image of the total targeted web page is previewed on the personalized web page.

### BACKGROUND OF THE INVENTION

The present invention relates to methods and apparatus for creating and/or using a personalized Web Page. In particular, it relates to a personalized web page which displays at least part of a targeted web page or an image of at least a part of a targeted web page that is updated so that on the personalized web page a more current version of the targeted web page.

Currently, many different pages developed as a hypertext page or web pages are connected to and accessible through a network. The network in general is the Internet and one collection of pages is known as the World Wide Web (WWW). One of ordinary skill will know that pages on the WWW are generally coded, for instance in a Hyper Text Markup Language (HTML) which can be correctly displayed in a browser often also displaying an image. A web page can be identified by entering or activating an address of such page, for instance in an address bar of a browser or by activating a link or address attached to a label displayed on a screen. An address of a web page can be a Uniform Resource Locator or URL. Once an address of a web page (such as a URL) is activated for instance in a browser on a screen of a computing device, the page is retrieved for instance in accordance with a protocol such as the Hyper Text Transfer Protocol (http) through the network from a server or computer where it is stored and after retrieval is displayed on a screen of the computing device, generally inside a browser.

There are hundreds of millions of web pages. One may search the Web with a search engine such as Google®, Bing® or Yahoo® for instance to find a web page of interest. However, selecting the correct web page from a list provided by a search engine may require reading or scanning a great number of items. Furthermore, to decide if a listed web page is of interest generally requires the actual opening of the web page. In many cases opened web pages may place a cookie on the machine from which the web page was opened, even if such web page turns out not to be of interest to a user. Some users may want to avoid collecting cookies from web pages that are of no interest to them. There is currently no system that allows a user to glance at parts of a plurality of web pages without actually having to visit such the pages.

Accordingly, new and improved methods and apparatus for displaying in a first web page which is called herein a personalized web page an updated image of at least a part of a second web page which is called herein a targeted web page are required.

### SUMMARY OF THE INVENTION

In accordance with an aspect of the present invention methods and systems are provided for creating and viewing a personalized web page which contains a capture of one or more targeted web pages, and wherein the capture of the targeted web pages on the personalized web page is updated automatically.

In accordance with an aspect of the present invention, a method is provided for displaying an image of a targeted web page on a personalized web page. The method includes the steps of: activating an address of the personalized web page to display the personal web page on a display screen of a computing device, entering an address of a targeted web page after activating an application, displaying the image of the targeted web page that is stored on a server not being a hosting server of the targeted web page, selecting at least a part of the image of the targeted web page, displaying the at least part of the image of the targeted web page on the display screen of the computing device as part of the personalized web page, and automatically updating the image of the targeted web page and the at least part of the image of the targeted web page. These steps are performed on a client computer, typically on a browser. Of course, the automatic updating is also performed by a server and that information is supplied to the client computer so that the images can be updated. The updating is preferably, but not necessarily, automatic. It can also be done on request by the client computer.

In accordance with a further aspect of the present invention a method is provided that further includes the steps of associating a design of the personalized web page with a user and displaying the personalized webpage according to the design on the display of a computing device after the user has signed on to the personalized web page. The design can be stored in a database on a server or it can be stored in a cookie.

In accordance with yet a further aspect of the present invention a method is provided, further comprising activating an application on the computing device to view the image of the targeted web page without contacting the hosting server.

In accordance with yet a further aspect of the present invention a method is provided, further comprising: enabling a user of the computing device to resize the at least part of the image of the targeted web page that is displayed on the personalized web page.

In accordance with yet a further aspect of the present invention a method is provided, wherein an update of the image of the targeted web page takes place automatically no later than 5 minutes after an earlier update.

In accordance with yet a further aspect of the present invention a method is provided, wherein an update of the image of the targeted web page that is displayed on the personalized web page takes place automatically no later than 1 minute after an earlier update.

In accordance with yet a further aspect of the present invention a method is provided, wherein revenues generated from displaying the personalized web page are shared with a party associated with the targeted web page.

In accordance with yet a further aspect of the present invention a method is provided, wherein the image of the targeted web page on the personalized web page is automatically updated when a user signs on to the personalized web page.

In accordance with yet a further aspect of the present invention a method is provided, wherein a party associated with the targeted web page opts in to allow automatic capturing an image of at least part of the targeted web page.

In accordance with another aspect of the present invention a method is provided for viewing a personalized web page by a user of the personalized web page. The method includes activating on a computing device an address of the personalized web page by the user, displaying the personalized web page including an image of at least a first part of a targeted web page selected by the user on a display screen of the computing device, wherein the image is displayed on a location and with a size inside the personalized web page that has been determined by the user of the personalized web page and wherein the image on the personalized web page that is displayed on the display screen is updated automatically. In accordance with other aspects of the present invention, the personalized web page can so display a plurality of targeted web pages.

In accordance with yet another aspect of the present invention a method for viewing is provided, wherein an image of the targeted web page that is displayed on the personalized web page is updated no later than 5 minutes after a previously captured image of the targeted web page was displayed on the display screen.

In accordance with yet another aspect of the present invention a method for viewing the personalized web page is provided, further comprising visiting the targeted web page for obtaining the automatically updated image of the targeted web page only during a time that the personalized web page is active on the computing device.

In accordance with yet another aspect of the present invention a method for viewing the personalized web page is provided, further comprising previewing by the user of the targeted web page on the display of the computing device without visiting a hosting server of the targeted web page.

In accordance with yet another aspect of the present invention a method for viewing the personalized web page is provided, further comprising cropping the image of the targeted web page on the personalized web page.

In accordance with a further aspect of the present invention a system is provided for creating a personalized web page, comprising a first server, including a memory, data storage, a processor and a connection to an Internet, in communication with a client computing device, the server enabled to execute instructions to perform the steps of generating data representing the personalized web page on the client computing device, saving an image of a targeted web page residing on a second server, transmitting data representing at least part of the saved image of the targeted web page to the client computing device to display on a display of the computing device as part of the personalized web page, automatically obtaining and saving an updated image of the targeted web page residing on the second server, and transmitting data representing at least part of the saved updated image of the targeted web page to display on the display of the computing device as part of the personalized web page.

In accordance with yet a further aspect of the present invention a system is provided, wherein the image of the targeted web page is updated automatically no later than 5 minutes after a previous update.

In accordance with yet a further aspect of the present invention a system is provided, further comprising the first server enabled to execute instructions to perform the steps of crediting a value to a party associated with the targeted web page.

In accordance with yet a further aspect of the present invention a system is provided, further comprising the first server enabled to execute instructions to perform the step of checking if a party associated with the targeted web page has opted in to allow saving an image related to the targeted web page on the first server.

In accordance with yet a further aspect of the present invention a system is provided, further comprising the first server enabled to execute instructions to perform the step of checking if a party associated with the targeted web page has opted out of saving an image related to the targeted web page on the first server.

In accordance with yet a further aspect of the present invention a system is provided, further comprising the first server enabled to execute instructions to perform the steps of automatically updating the image of the targeted web page when the personalized web page is activated.

A variety of other methods and apparatus in accordance with various aspects of the present invention are disclosed herein.

### DESCRIPTION OF THE DRAWINGS

FIG. 1 is a diagram of a system in accordance with an aspect of the present invention;

FIGS. 2-7 illustrate a web page in accordance with an aspect of the present invention;

FIG. 8 illustrates a method described herein in accordance with one or more aspects of the present invention;

FIG. 9 illustrates a computing device such as a client or a server in accordance with at least an aspect of the present invention; and

FIGS. 10-27 are screen shots that illustrate one or more aspects of the present invention.

### DESCRIPTION OF A PREFERRED EMBODIMENT

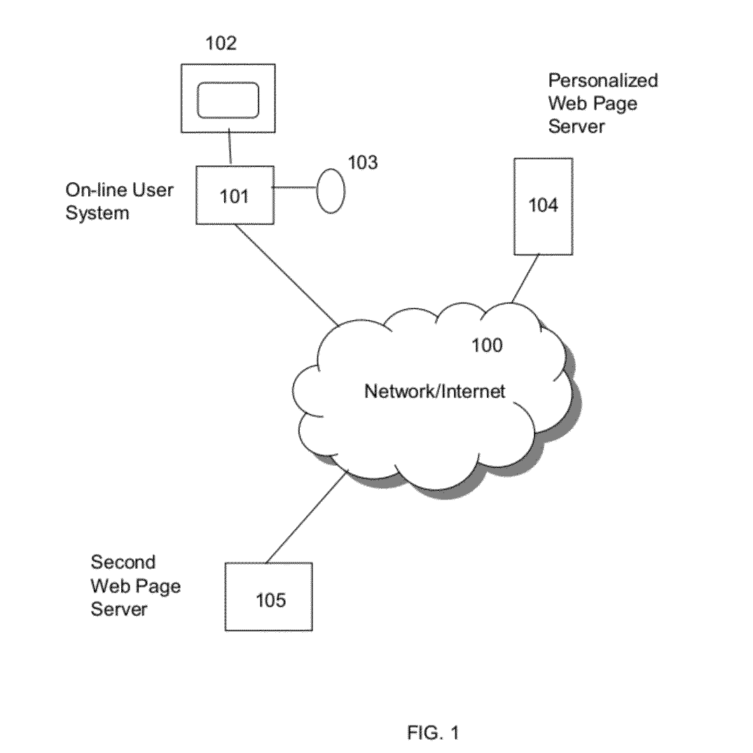

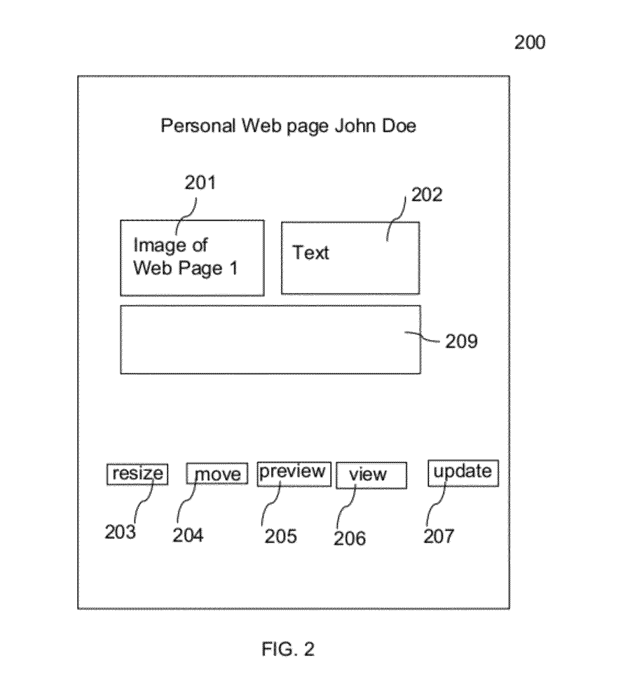

As a first aspect of the present invention an apparatus and a method are provided for displaying and for using a personalized web page. This is illustrated in FIGS. 1 and 2. FIG. 1 illustrates a system for displaying a personalized web page in accordance with an aspect of the present invention. The personalized web page is hosted on a server 104 which is connected to a network 100, which may be the Internet. The cloud 100, representing a network such as the Internet, not only includes network connections, but also required infrastructure equipment to enable transfer of a web page from a server 104 to a computing device 101 or any other device that is connected to the network 100. A user of computing device or On-line User system 101 is viewing a personalized web page hosted on 104 and which has an address (such as a Uniform Resource Locator or URL) which enables the computing device to locate the personalized web page and to download it for viewing on a display 102. A user has control over the system 101 with an input or control device 103, which may be a mouse, a keyboard or any other input device as is known in the art. In accordance with an aspect of the present invention, the personalized web page as displayed on 102 includes an image of a web page which is hosted on server 105 which is also connected to network 100. An image is captured of the web page hosted on 105 and stored as an image on 104.

In one embodiment, server 104 may store a copy of a web page that originates on server 105. The server 104 may act as a proxy for server 105. The server 104 in such an embodiment updates the stored web page on a regular basis, for instance at least every 1 minute or at least every 5 minutes or at least every hour or on an update schedule that meets a need of a viewer of a personalized web page with a capture of the targeted web page. In this embodiment, also an image of the targeted web page may be stored on server 104.

A capture of a web page in one embodiment is an image of a web page. Thus, in this embodiment of the present invention, when a targeted web page is captured, the image of the targeted web page is used. Such an image may, for instance, be created by rendering a web page based on its design code as it would appear inside a browser and creating an image in for instance JPEG or other known or future format. In another embodiment, one may render a web page on a server and transfer a version of such rendering to a personalized web page. An image of a targeted web page is one embodiment of a capture of a targeted web page and other embodiments of a capture of a targeted web page are fully contemplated. Thus in one embodiment of the present invention, the term “image of a web page” or “image of a targeted web page” is intended to also mean “capture of a web page” or ‘capture of a targeted web page.”

After client 102 connects to server 104 to display the personalized web page stored at server 104, an image of at least a part of the targeted web page hosted on server 105 is provided to client 102 over the network. The server 104 is programmed to be aware that a captured image of a targeted web page residing on 105 is part of the personalized web page that is displayed on client 102. The captured image is associated with the address of the targeted web page on 105.

The server 104, in one embodiment of the present invention, is programmed to re-visit the web page on server 105 to capture an updated image of the targeted web page. Such updating may take place on regular intervals. The update interval can be a predetermined interval. For instance, an update interval in one embodiment of the present invention is less than 30 seconds. In another embodiment of the present invention the update interval is less than a minute. In yet another embodiment of the present invention the update interval is less than 5 minutes. In yet another embodiment of the present invention the update interval is less than 15 minutes. In yet another embodiment of the present invention the update interval is less than 60 minutes. In yet another embodiment of the present invention the update takes place at most once a day. All updates are performed automatically. It is believed that automatically updating an image of a targeted web page is novel.

In another aspect of the present invention, the period of an update is variable. For instance available bandwidth for obtaining an update may necessitate a variable schedule for updating. A targeted web page may, for instance, be preferably scheduled to be updated about every 5 minutes, but may have to wait for 10 minutes between updates if there is too high a demand for bandwidth. Update requests for other targeted web pages may also cause a variable update schedule. Furthermore, it may be known that a targeted web page host server 105 has more updates around peak viewing hours, rather than for instance between 2 am and 5 am in the morning. The server 104 may be programmed to follow the update schedule of server 105 to update a capture of the targeted web page. For instance, server 104 may check server 105 if file names and file stamps have been changed (as described herein) before deciding if an update is required. In such a case server 104 will only update the capture of the targeted web page if the targeted web page itself has been updated. For instance, a targeted web page may be a news web page which is only updated with breaking news. In that case the updating may not follow a fixed time schedule, but a variable schedule.

The server allows a user of a personalized web page to view a captured image of a targeted web page that is automatically updated anywhere on the personalized web page, on a user preferred location of the personalized web page with a user determined size and zoom factor of the captured image, or in a program preferred location of a personalized web page. Such preferred locations of displayed targeted web pages are, for instance, shown in FIG. 2, wherein displayed targeted web pages and possibly accompanying text are arranged in columns and rows, wherein targeted web page 201 occupies one row and one column and targeted web page 209 occupies two columns and 1 row. In a further embodiment, a displayed targeted web page may occupy more than one row.

A user may create a design for a personalized web page. This design, including user preferences related to the address of the targeted web page, the preferred display location and the preferred size are all stored as part of the design on server 104 and are applied as soon as the address of the personalized web page is activated on the server 104. In one embodiment, a user will sign-on to the personalized web page by first enabling an address of a web page and then providing, for instance, a user name and password. A personalized web page design, in one embodiment of the present invention is stored on server 104 in a database and is associated with the user name. Such a database may be a MySQL database or any other database that can be applied. When the user signs on to the web page, the design is retrieved and a web page is generated to be displayed on display 102 in accordance with the design. There are different ways to create a personalized web page in accordance with a design. For instance, a cookie may be saved on the client device 101 allowing the server 104 to recognize the user device and to apply a specific design for the personalized web page. The design could also be stored on the cookie.

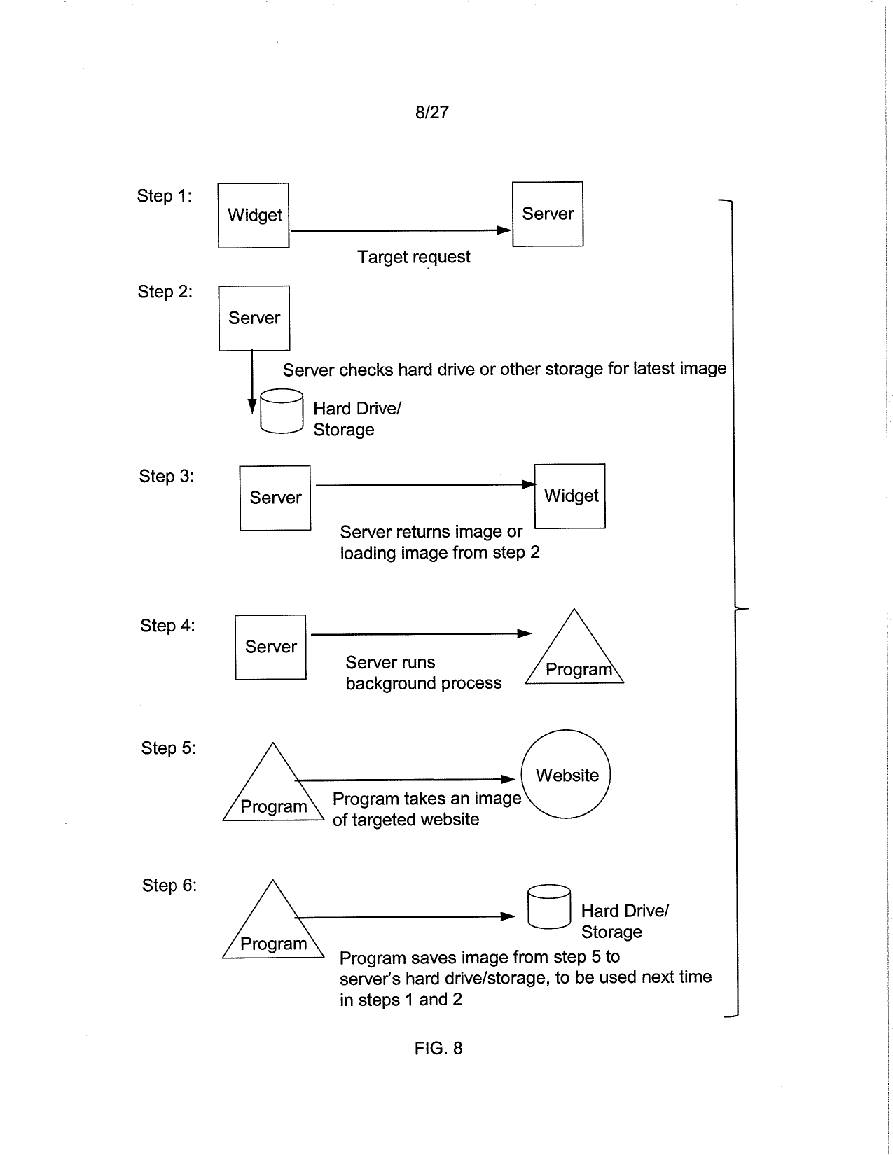

The address of a targeted web page that is shown on a personalized web page is part of the design displayed on the client computer. As soon as a user signs on, the design is retrieved which includes the address of the targeted web page. Based on this address the server 104 will start a process to provide the appropriate image, which will be explained later herein and illustrated by FIG. 8.

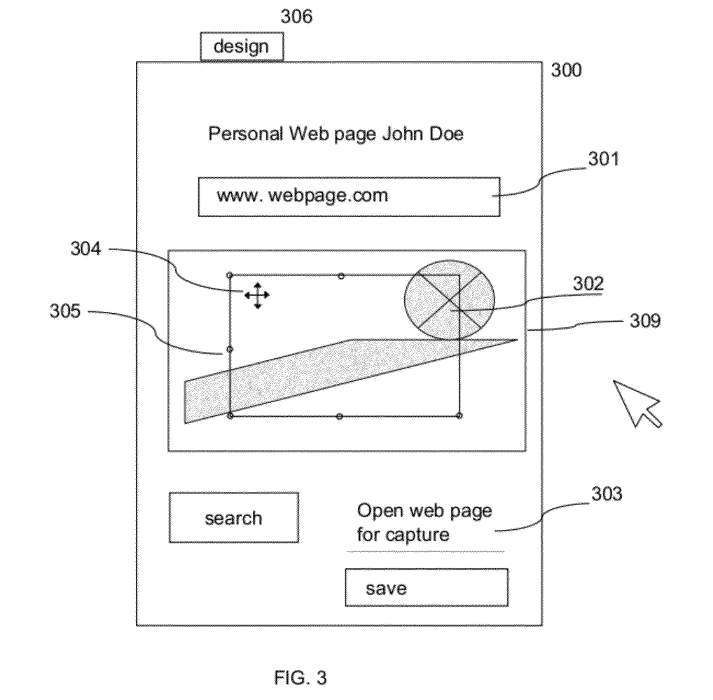

In one embodiment of the present invention, the server 104 will only update the captured image of the targeted web page on the personalized web page when the personalized web page is being displayed or when its address is active. For instance, a lay-out or a design of the personalized web page has been stored and the personalized web page is being activated by a user. The server 104 retrieves the data related to the web page and sends the data to device 101. As soon as the personalized page is being activated the server is instructed to update all images that capture a targeted web page, for instance by a background process as shown in FIG. 3. Especially, if a many different users each have at least one targeted web page that is unique to a user, it requires a continuing update of many different web pages. To prevent unnecessary use of bandwidth, updating of an image of a targeted web page, in one embodiment of the present invention, only happens when at least one personalized web page associated with the targeted web page is active.

In a further embodiment, each of a plurality of different personalized web pages refer to at least one common web page, such as the Yahoo® web page for instance, or to a news web page such as CNN®. In that case, it saves bandwidth and processor time by referring to a common image or capture of such a common targeted web page, and only update this common capture or image, rather than generate an individual image for each of the plurality of personalized web pages. This affects the design phase of a personalized web page, which will be explained later herein. The use of a ‘popular’ web page as a targeted web page for different users is addressed in at least one embodiment of the present invention. When a user enters or activates during a design phase of a personalized web page an address of a targeted web page, the system 104 will check in a database if the targeted web page associated with the address has been included in other personalized web pages and/or if the targeted web page has an active status in other personalized web pages. Such an active status, in one embodiment of the present invention, means that a capture or an image of this targeted web page has been actively updated during a recent period or is on an active list for updating. If the status is active, it means that a client 101 that wants to include the targeted web page on its personalized web page can be provided with a recently updated capture or image stored on 104. The capture or image of the targeted web page will be updated at the next occasion of automatic update and provided or distributed to all active personalized web pages that apply the targeted web page. For that reason, server 104 has a distribution list that includes all clients that need to be updated when an update on the targeted web page is available. Such a distribution list, in a further embodiment of the present invention, is part of a database.

A user can also manually instigate an update, for instance, by activating the update process from client 101. Such an instruction, which may be a refresh instruction, instructs the server 104 to capture an updated image of a targeted web page captured and displayed on a personalized web page. This forced update may be executed, even if no changes have taken place at the targeted web page and no noticeable changes have taken place.

In many cases, at least part of a targeted web page is a high quality image of which transmission requires substantial bandwidth and/or transmission time. In many cases, components of a web page such as an HTML file or an image file have a unique characteristic. Such a characteristic may be a unique name or a time or date stamp that will change if a new version is uploaded. For instance a name changes, a size changes or a time stamp changes with a new version of a file. It is thus not unreasonable to assume that if a name and/or a time stamp or any other noticeable property of a file that is part of a targeted web page has not changed after a last visit that the component self such as an image or text has not changed and an update which require a transmission of a file from the server 105 to server 104 is not required. In one embodiment of the present invention the server is programmed to detect if a change in the web page has taken place. If no noticeable change has occurred, the server 104 provides to client 101 a visible stamp or message for instance in the image or that will overlay the image. Such a stamp in one embodiment of the present invention indicates that no changes have been detected, or in another embodiment provides a stamp that indicates that the image is a recent image.

FIG. 2 provides an illustrative diagram of a personalized web page 200 in accordance with an aspect of the present invention. Such a page is stored at a server 104 and data represented on the personalized web page is sent by the server 104 to a computing device 101 to be displayed on screen 102 once an address of the web page has been activated by the device 101. The page 200 can have many features. In accordance with an aspect of the present invention, the personalized web page 200 shows an image 201 that captures at least a part of the targeted web page. In one embodiment of the present invention, the image 201 can be positioned anywhere on the personalized web page 200. Preferably, the size and position of image 201 is decided during a design phase, wherein the position and size of image 201 are set and saved. During operation and activation of the personalized web page 200, the captured image 201 is displayed on the personalized web page 200 at the predetermined location, by using the location and size parameters that were determined and saved during the design phase.

During the design phase, an image of a targeted web pages is displayed on a local computer, a part of the image of the targeted web page is selected and this information and this information is stored as a design. The location of the display of the targeted web page can be selected. The design can be stored on the server. When a SAVE button is hit, then the local computer implements the operational phase, and one or more targeted web pages (the selected parts) are displayed. A plurality of targeted web pages can be selected by sequentially entering the design phase. In this manner, in accordance with an aspect of the present invention, a plurality of targeted web pages (again the selected parts) are displayed on a local computer. The server 104 updates those targeted web pages so that a user at computer 101 can view multiple targeted web pages simply by turning on his or her computer. Thus, a user at computer 101 can select their favorite sports web site, favorite investing web site, favorite news web site, favorite blogs, favorite weather web site, etc. and then view each targeted web site by turning on the computer 101. By associating the design of targeted web pages to view with a user name (and password), all of the selected targeted web pages can be viewed at any computer on the Internet where a user signs into the server 104.

The captured image can be accompanied by a comment or text box 202, as known in the art, and that allows a viewer to provide text related to the image. The position and size of the text box 202 may also be decided during the design phase. In one embodiment of the present invention, the text box 202 is a static text box, which can only be modified in a design phase or a maintenance phase of the personalized web page 200. In another embodiment of the present invention, the text box is a comment text box or an entry box wherein a viewer can provide a text comment or another input such as an image or a sound recording preferably related to the image 201.

In a further embodiment of the present invention, a personalized web page 200 with an image 201 that captures at least part of a targeted web page and which image is updated has at least one activatable menu item related to the image 201. These activatable menu items are illustrated in FIG. 2 as clickable buttons 203, 204, 205, 206 and 207. However, it is fully contemplated that menu items related to 201 can be displayed and activated as a drop-down menu, as a menu activated by right-clicking a mouse button or in any other way that lists a menu with menu items and that allows to activate at least one menu item. While menu items 204-207 are provided for illustrative purposes, it is contemplated that more or fewer menu items can be associated with a personalized web page as provided herein. One such menu item can be a ‘design’ button that brings the personalized web page back into a design mode or that activates a ‘design’ widget or any other widget or web widget as these applications are often called.

Button 203 represents an activatable menu item ‘resize.’ Activating 203 allows a user to resize the window of image 201 with for instance a pointing device such as a mouse. By activating 203, handles appear on 201 that allows enlarging or diminishing the size of 201. In one embodiment of the present invention the actual size of the view of the targeted web page is set during the design phase. Enlarging the window of 201 may maintain the same image but increase the zoom factor. It may also increase the viewable area of the related image. The moving and resizing of an image may be a “free” operation allowing any practical size or position. A moving and/or a resizing may also be limited to predetermined size and position, for instance determined by a grid or column/row structure of the personalized web page.

In one embodiment of the present invention, an image is stored on the server 104 that hosts the personalized web page that captures an image of a larger part or the total targeted web page and which is stored on the hosting server 104 of the personalized web page. The part of the targeted web page that was selected to become 201, in an embodiment of the present invention, defines a set of parameters that is stored as part of the design of the personalized web page. When the personalized web page is active, the image related to the total targeted web page will be uploaded to the computing device for viewing the personalized web page but only the selected part of the stored image of the targeted web page will be displayed. In the alternative, a program on the server during uploading of the personalized web page to the computing device for viewing the personalized web page will generate only the image 201. When menu item 203 is activated, the computing device 101 may request a new and changed image 201 from the server, which will create the changed image from the stored image of the targeted web page and upload it for display to the computing device. In a further embodiment of the present invention, the client 101 receives the complete image of the targeted web page and is programmed to display only part 201 of the capture of the complete targeted web page. Such a display program may be part of a browser or a plug-in to a browser on client 101 or may be HTML code that is part of the personal web page.

Menu item 204 when activated will allow image 201 to be moved over the personalized web page.

Menu item 205, when activated, will display a captured image of at least a larger part of the targeted web page than is provided by 201 and preferably an image of the complete targeted web page. In a further embodiment of the present invention, the displayed image of the complete targeted web page is linked to the actual targeted web page. Clicking on the displayed image of the complete targeted web page will activate the address of the targeted web page for display.

Menu item 206 when activated will activate the address of the targeted web page and display the targeted web page on client 101.

Menu item 207, when activated, will instruct the server 104 to capture an updated image of the targeted web page on 105. This allows a user to force the server 104 to create an updated image of the targeted web page. In a further embodiment of the present invention, an instruction 207 to update relates to all captured images representing different targeted web pages and not just the targeted web page hosted on 105.

FIG. 3 further illustrates a design phase of the personal web page on client 101. When a user activates the address of the personal web page, it may appear at first in an operational form for only viewing the page. An instruction of an application has to be activated to design a part for inserting an image of a targeted web page. For instance, a user may right click on a mouse with its related cursor inside the personalized web page 300. This may activate a menu with at least a choice to insert an image of a targeted web page. The page (or a browser in which the personalized web page is rendered) may have a special ‘design’ button 306 that places the page in a design mode. The design application may be called a widget or a web widget.

When the design mode is activated, a program may create an entry window 301 to enter an address of the targeted web page. A window 309 will show an image of the targeted web page. A selecting window 302 is placed preferably inside 309 that defines an image that will capture at least part of the targeted web page. The window 302 has handles 305 to change the size of the window and a handle 304 to move the capturing window 302. By moving the selecting window 302, a part of the targeted web page is selected for viewing during the operational phase.

In one embodiment of the present invention, a targeted web page is selected by entering its address or URL in 301. In another embodiment of the present invention, one may want to search for the targeted web page, for instance by using a search engine. Other embodiments of the present invention to select a targeted web page are fully contemplated, including selecting from a pre-saved list. To enable selecting one of a plurality of selecting methods menu options are provided, for instance in the form of buttons. In FIG. 3, a button 303 is provided that, when activated, enables directly entering an address by opening address window 301. It is shown in FIG. 3 that an address www.webpage.com has been entered. By confirming the address entry, for instance by hitting ‘ENTER’ on a keyboard, the address is activated and the targeted web page is displayed in the window 309.

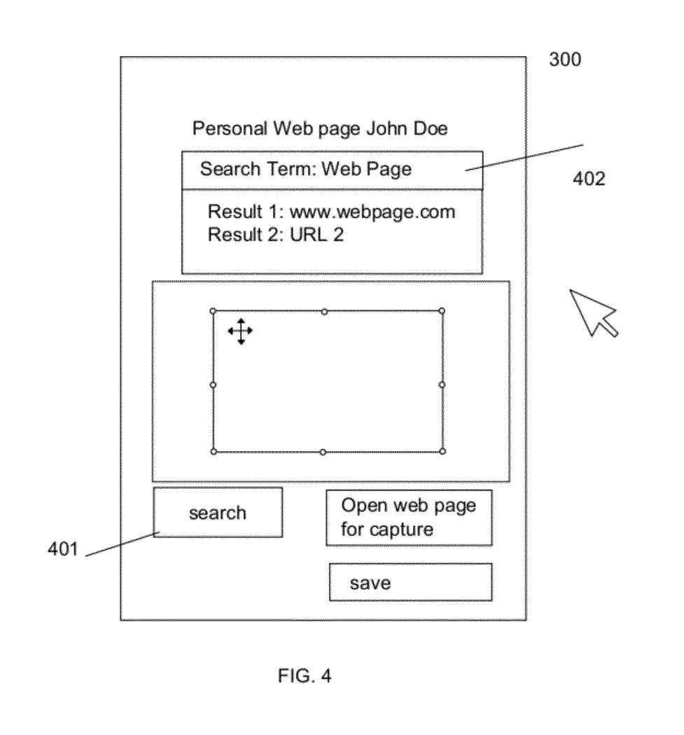

In one embodiment of the present invention, one may search for a targeted web page by activating a ‘search’ function, for instance by activating button 401 as shown in FIG. 4. Activating the search function opens a search window 402 wherein a search term can be entered, for instance the search term Web Page. This brings up results as shown in FIG. 4 of which result 1 is the address of the targeted web page with address www. webpage.com. This web page can be activated by for instance double clicking the address. It should be clear that different methods exist to activate a targeted web page during a design phase of the personalized web page.

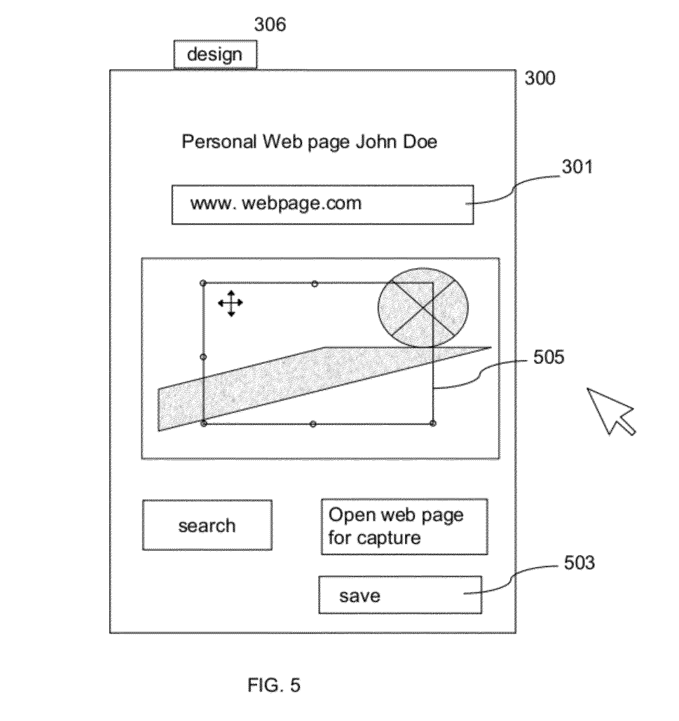

FIG. 5 shows the page 300 again in the design mode. A selection or cropping window 505 has been placed in a desired position over an image of the targeted web page www.webpage.com and 505 reflects the desired format of at least a preferred size of how the targeted web page is to be displayed on the personalized web page on 101. By adjusting the cropping window 505, a selected part of the targeted web page is displayed. The design is saved by clicking on ‘save’ button 503. In one embodiment of the present invention, clicking ‘save’ will also return the web page 300 to its operational mode.

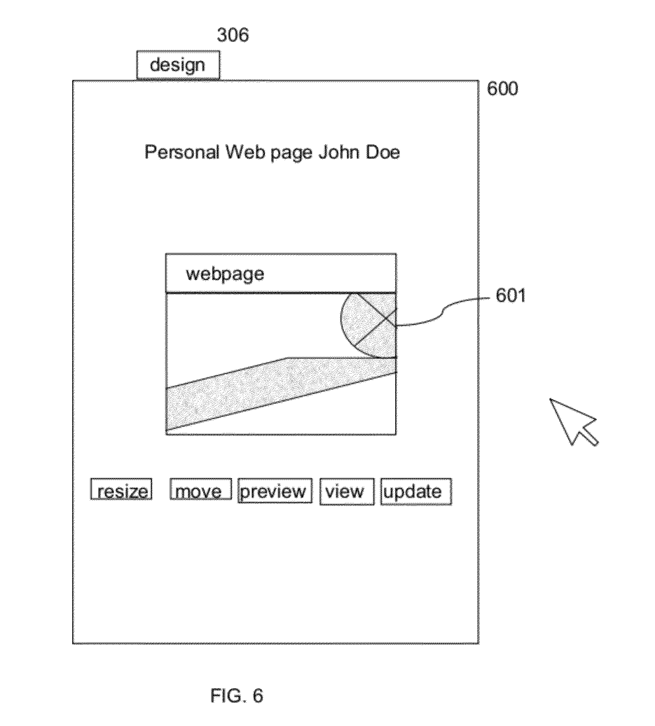

FIG. 6 illustrates the personalized web page 600 on computer 101 after design has been completed. It shows a capture 601 of the captured targeted web page in its preferred size. The buttons ‘resize’, ‘move’, ‘preview’, ‘view’ and ‘update’ for the related widgets indicate that the personalized web page is now in operational mode. A caption, in this example on top of the window, is provided to indicate a name for the targeted web page.

The image inside 601 will be updated in accordance with an aspect of the present invention.

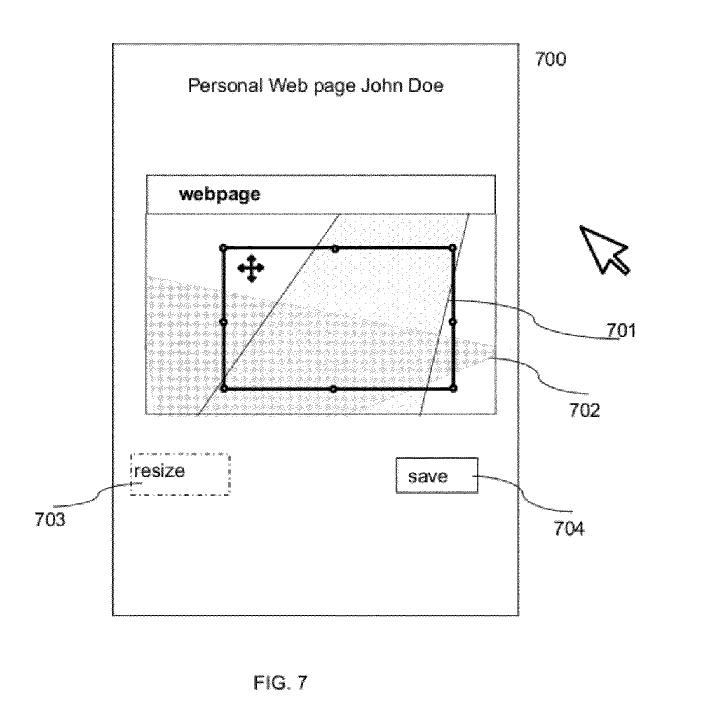

FIG. 7 illustrates the personalized web page 700 after the widget or button 703 (resize or crop) has been activated. The page 700 goes in a design mode. The whole image of the targeted web page or at least a large picture of the targeted web page will be shown in 702. Also a cropping window 701 will become active allowing a user to select a size and position of a captured image. By putting the page in ‘cropping mode’ a button ‘save’ becomes active. After a user has put the cropping window in a desired size and position the new design will be saved by activating the ‘save’ button 704. After activating button 704 the personal web page 700 will return to its operational display mode.

Windows herein, such as window 701 are shown as rectangles. However, the windows can have any shape and in one embodiment of the present invention can be created or selected by a user connected to a hosting server of the personalized web page.

Activating the ‘saving’ in one embodiment of the present invention will return the personalized web page from design mode into operational mode as is shown in FIG. 7. In the operational mode the personalized web page is displayed according to its saved design. In a further embodiment of the present invention all activating options, as explained earlier, are also provided on the active personalized web page in operational mode. It is fully contemplated that return from design mode to operational mode in the personalized web page in one embodiment of the present invention has to be achieved by activating a dedicated ‘return’ command, thus allowing a user to continue to design a personalized web page with a plurality of targeted web pages during a single design session until the design session is terminated by a ‘return’ command.

The personalized web page in operational mode, in one embodiment of the present invention, has the ‘design’ menu item 306 available to be activated to allow editing of the design. In yet a further embodiment of the present invention the ability to change a design of a personalized web page requires a sign-in, for instance with a user-name and a password as is known in the art. In such an embodiment a operational personal web page has no or very limited design capabilities, for instance only design capabilities that are active during viewing of the personalized web page and only for a specific client that is used for viewing the personalized page and from which the design changes were made. This allows viewing of a personalized web page by different viewers without allowing unauthorized viewers to change the design of a personalized web page.

In one embodiment of the present invention, a personalized web page is provided with an advertisement which will generate compensation when the advertisement is activated. The advertisement placement may be generated based on the presence of the image of the targeted web page on the personalized web page. Compensation generated by a user clicking on the advertisement or activating the advertisement in one embodiment of the present invention is shared with a party associated with the targeted web page. Such an associated party may be a hosting party or an owner of the targeted web page or any party that is authorized on behalf of an owner of the targeted web page.

In a further embodiment of the present invention, the targeted web page attracts one or more visits from visitors of the personalized web page by a visitor of the personalized web page activating the targeted web page through the image of the targeted web page on the personalized web page. The targeted web page in this further embodiment of the present invention also has at least one advertisement that will generate compensation for a party associated with the targeted web site such as an owner. In this further embodiment of the present invention a visitor of the targeted web page that enters the targeted web page via the personalized web page and who clicks an advertisement on the targeted web page will generate compensation that is shared with a party associated with the personalized web page.

In one embodiment of the present invention, for instance based on the prospect of obtaining additional traffic or compensation, a party associated with the targeted web page will opt in to a program to have a personalized web page use an image of the targeted web page that is updated for instance on a regular basis. Such a formal opt in may include measures to facilitate creating captured images of the targeted web page. For instance, a targeted web page when it is updated may itself generate an image that captures the updated targeted web page and send it to the server of the personalized web page.

In one embodiment of the present invention, a party associated with a targeted web page may opt out of having a personalized web page use an image of the targeted web page that is updated for instance on a regular basis. The server of the personalized web page may screen requests for images of the targeted web page and generate a generic message or a blank image instead of an image of the targeted web page.

FIG. 8 illustrates the steps that are performed in one embodiment of the present invention to provide an image of a targeted web page.

In step 1, an application or widget on a client, such as client 101 provides to a server such as server 104 in FIG. 1 a target request, for instance, for an image of a targeted web page.

In step 2, the server checks its hard drive, or any other storage media where it may have stored images for the most recent image of the targeted web page.

In step 3, if such an image is available the server provides the widget on the client computer with the image.

In step 4, the server starts and runs a background process to obtain an image of the targeted web page. This may be for one of several reasons. For instance, the server has no stored image of the targeted web page. Or, there is a stored image but the image has not been updated recently and the server is instructed to update the image.

In step 5, as part of the background process a program is initiated that will visit the targeted web page and that captures an image of the targeted web page.

In step 6, the program receives the updated image of the targeted web page and stores in on the hard drive or other relevant storage medium, where it is available to be used if steps 1 and/or 2 are again initiated.

The updating process is done automatically in accordance with an aspect of the present invention.

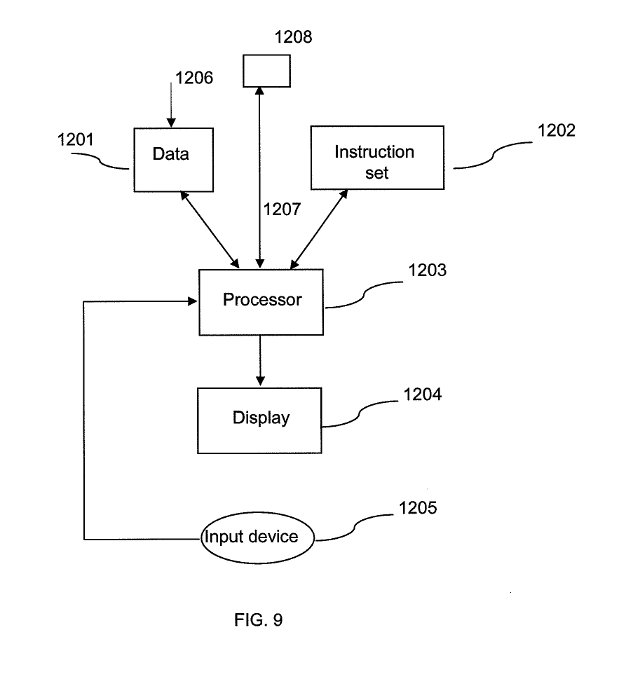

The methods that are aspects of the present invention can be executed by a system or computing device as shown in FIG. 9. The system is provided with data 1201 which is provided on an input 1206. An instruction set or program 1202 executing the methods of the present invention is provided and combined with the data in a processor 1203, which can process the instructions of 1202 applied to the data 1201. Any signal resulting from the processor can be outputted on a device 1204. Such a device for instance can be a display. However, in an operational situation such device may also be an output device to provide a message to a network or a network connection to another computing device. The processor can be dedicated hardware. However, the processor can also be a CPU or any other computing device that can execute the instructions of 1202. An input device 1205 like a mouse, or track-ball or other input device may be present to allow a user to select an object on a display. The input device may also be a keyboard to enter data. The input device may also be used to start or stop instructions and activate applications on the processor. In a further embodiment of the present invention the system or computing device is connected via a connection 1207 to a network, for instance via a network device 1208 which may implement a network interface. Accordingly the system or computing device as shown in FIG. 8 provides a device that can be applied to optimize on-line advertising using a method disclosed herein.

During updating, the computer 101 contacts server 104 for the latest update of targeted web page. Computer 101 continually contacts the server 104, for example, every 15 or 30 seconds, although this interval can change. This is implemented in a widget or a plug-in the server 104 sends to the computer 101. It could also be implemented in a special browser. If there are multiple targeted web pages to be viewed, then computer 101 contacts server 104 sequentially for each targeted web page. The server 104, assuming it has already acquired an image of the targeted web page, sends the targeted web page to the computer 101. The server 104 also checks the currency of the targeted web page and, based on a set interval as described herein, the server 104 obtains an updated targeted web page (if necessary) and sends that to the local computer 101 for display. Again, the server 104 does this sequentially for each targeted web page on the computer 101. The server 104, in this way, handles each user on the system.

If the server 104 receives a new targeted web page, it sends an image back. The server 104 can send a loading image or, if it has time to acquire the targeted web page, it can send the targeted web page.

The server 104 sends an image of the entire targeted web page to the computer 101. The computer 101 implements its design to crop the image of the targeted web page and displays this cropped image during the operational phase.

Alternatively, during updating, the server 104 obtains current versions of the targeted web pages for all users connected to the server 104. This is done according to a list of users and associated designs maintained at the server 104. After the server 104 updates all of the targeted web pages, the server 104 checks which users are active and sends images of targeted web pages, in accordance with each user's design of selected targeted web pages, to each user. The user's computer then applies its design to select a part of the targeted web page to display during the operational phase of the operation of local computers 101. Alternatively, the server 104 could perform the cropping step, although this places a large burden on the server.

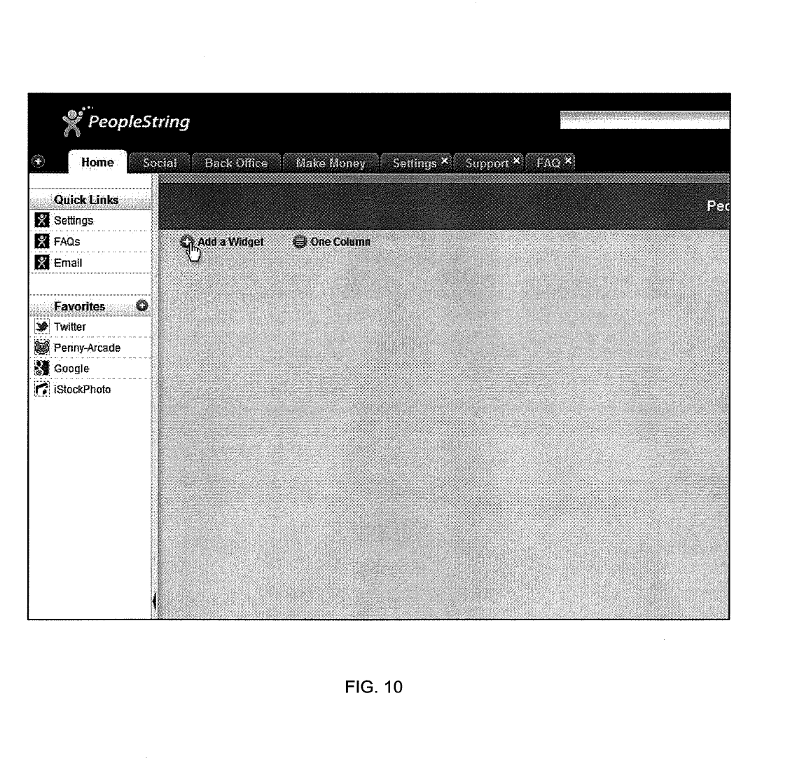

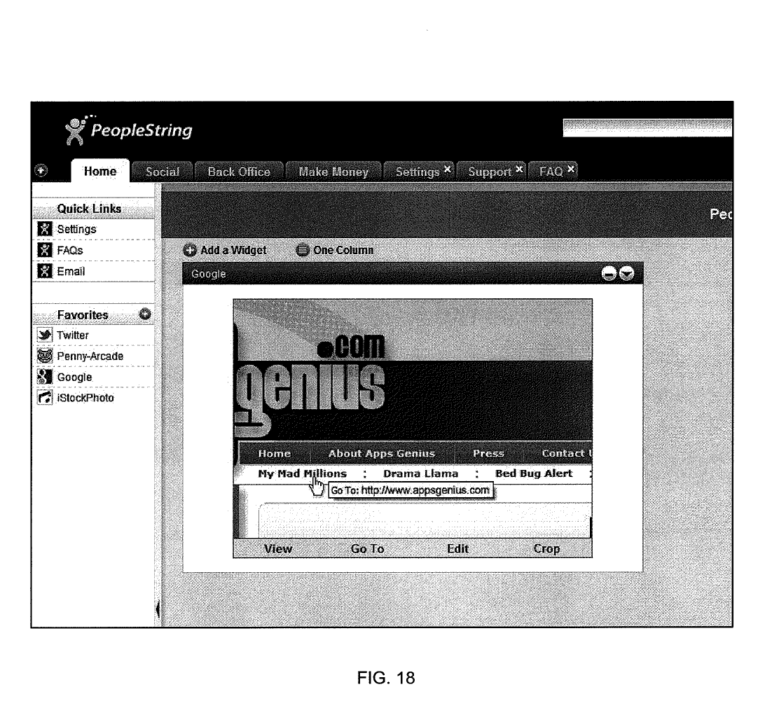

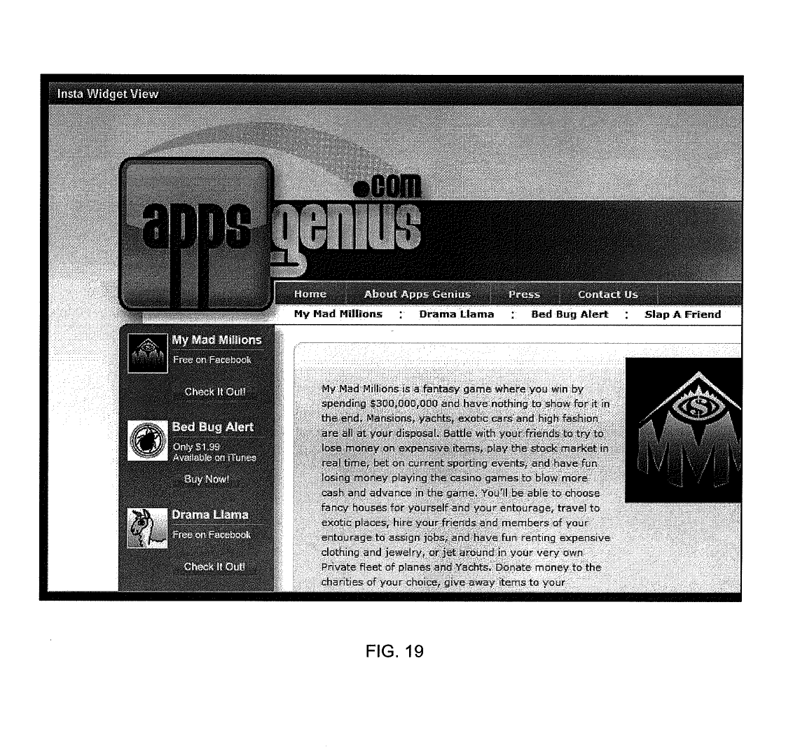

FIGS. 10-27 illustrate one or more of the methods and systems as provided herein by showing illustrations of screen shots of a display of a client such as client 101 in FIG. 1.

FIG. 10 shows a screen wherein a widget is selected.

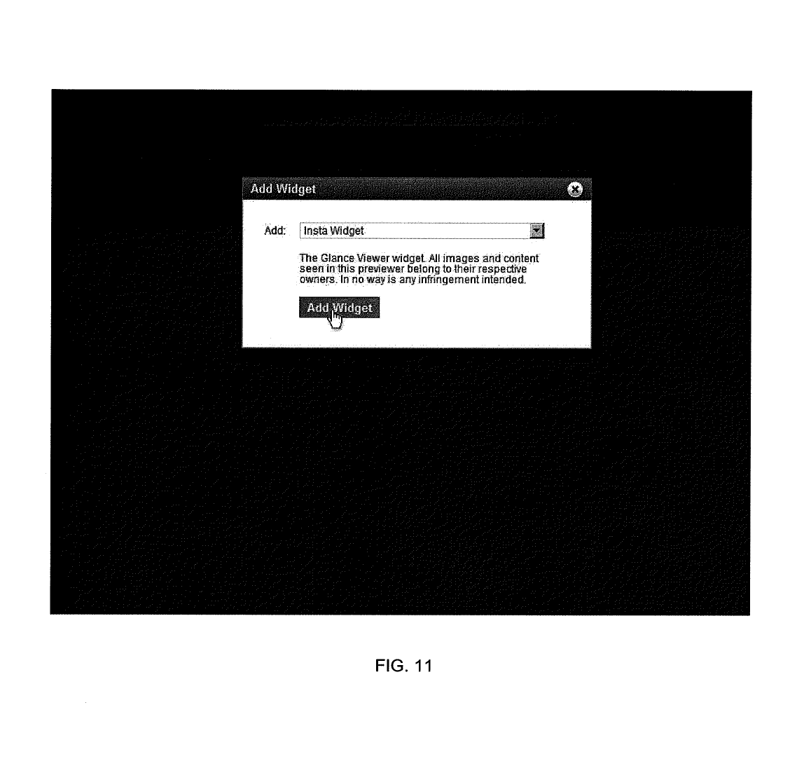

FIG. 11 shows a screen shot wherein a widget is selected that will enable creating a capture of a targeted web page.

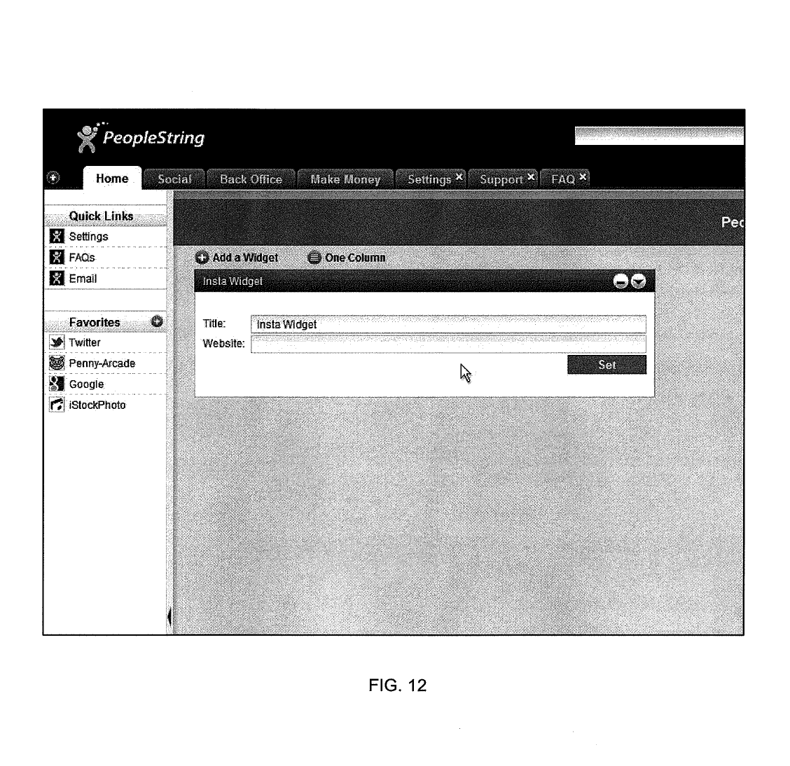

FIG. 12 shows a screen shot wherein the widget asks for the name or address of a targeted web page.

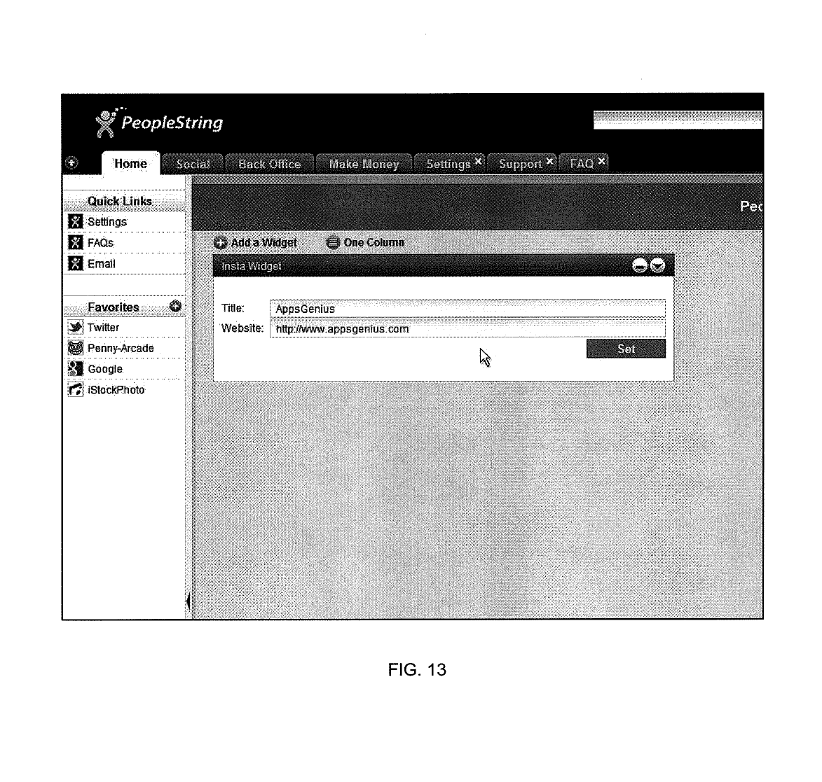

FIG. 13 shows a screen shot wherein the address of the targeted web page is entered and a title or name for the targeted web page is provided.

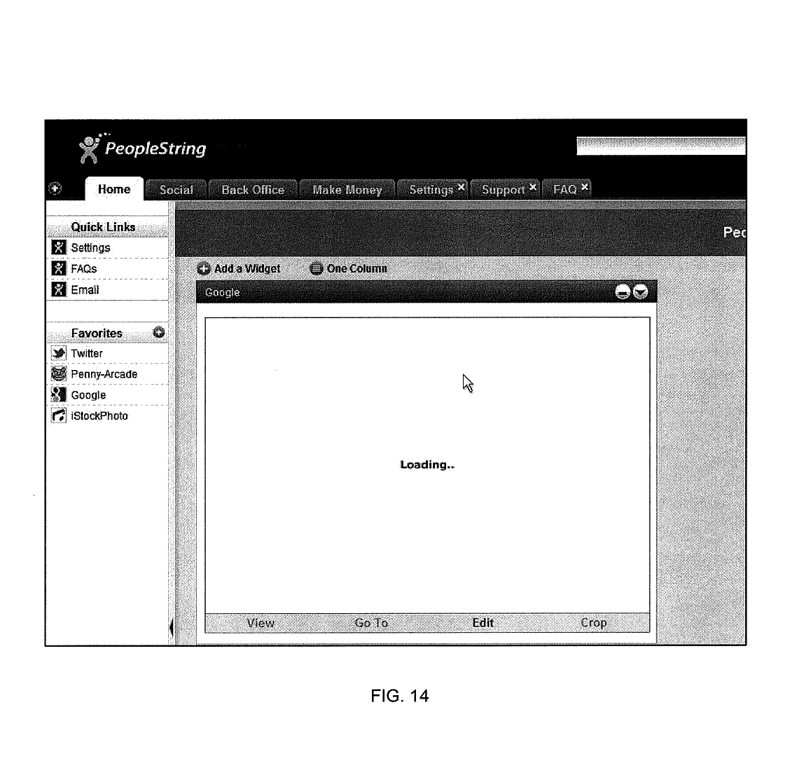

FIG. 14 shows a screen shot showing that a capture (usually an image) of the targeted web page is being loaded.

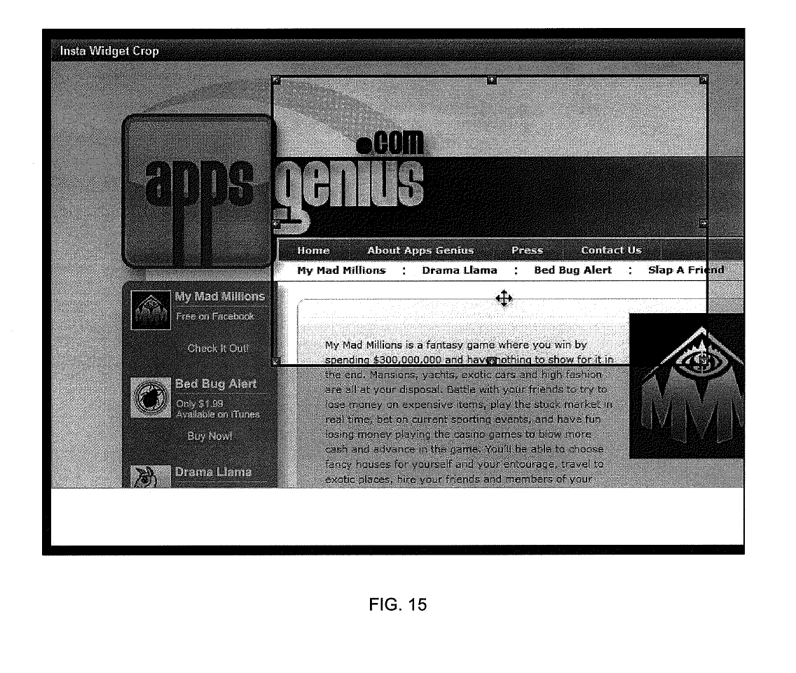

FIG. 15 shows the image or capture of the targeted web page with a cropping window for a user to select how to display an image or capture of the targeted web page. A save button (which is outside the view of this screen shot) saves the design and brings the personalized web page in operational of display mode.

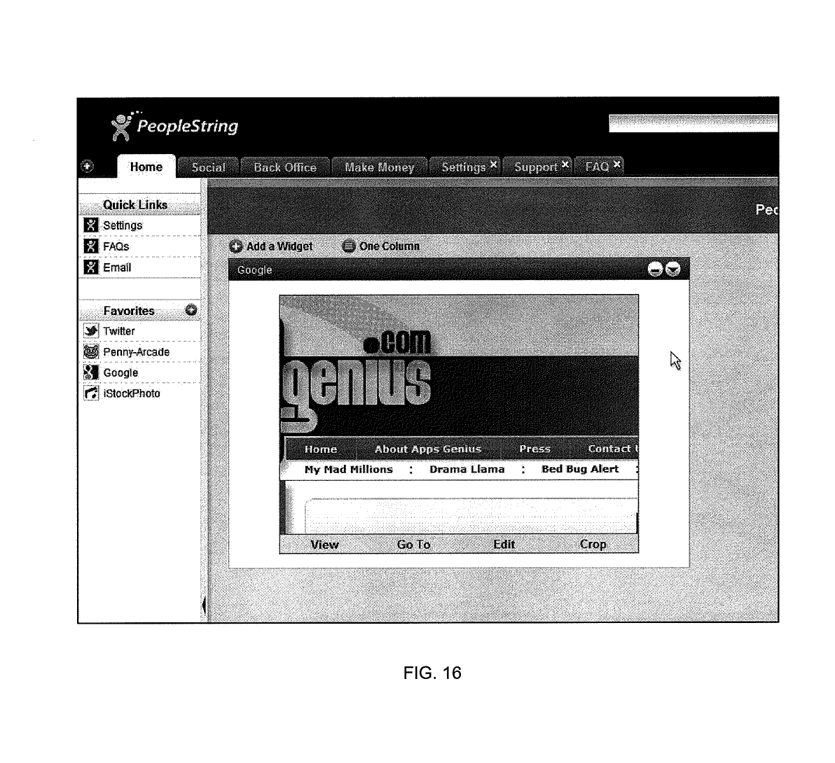

FIG. 16 shows the personalized web page in operational or display mode. Also displayed are four activatable applications or widgets ‘View’, ‘Go To’, ‘Edit’ and ‘Crop’.

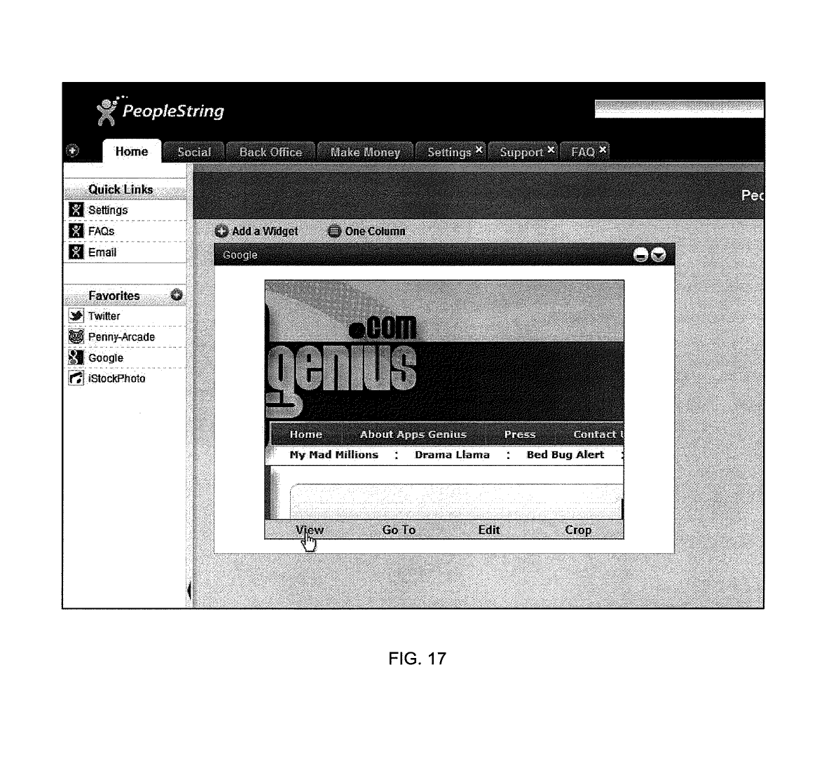

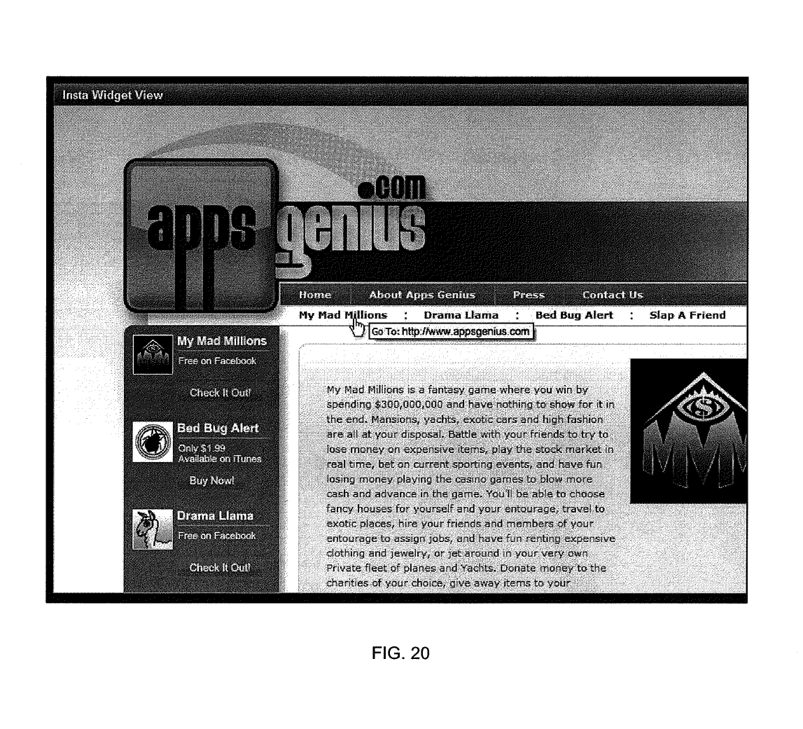

FIGS. 17-19 are screen shots wherein in operational mode of the personalized web page the application ‘View’ is activated and a capture or image of the complete targeted web page is being shown. FIG. 20 shows that clicking on the image will activate and bring up the actual web page. Outside the field of view is a button which may have a caption cancel that returns the client 101 from ‘View’ mode to operational mode.

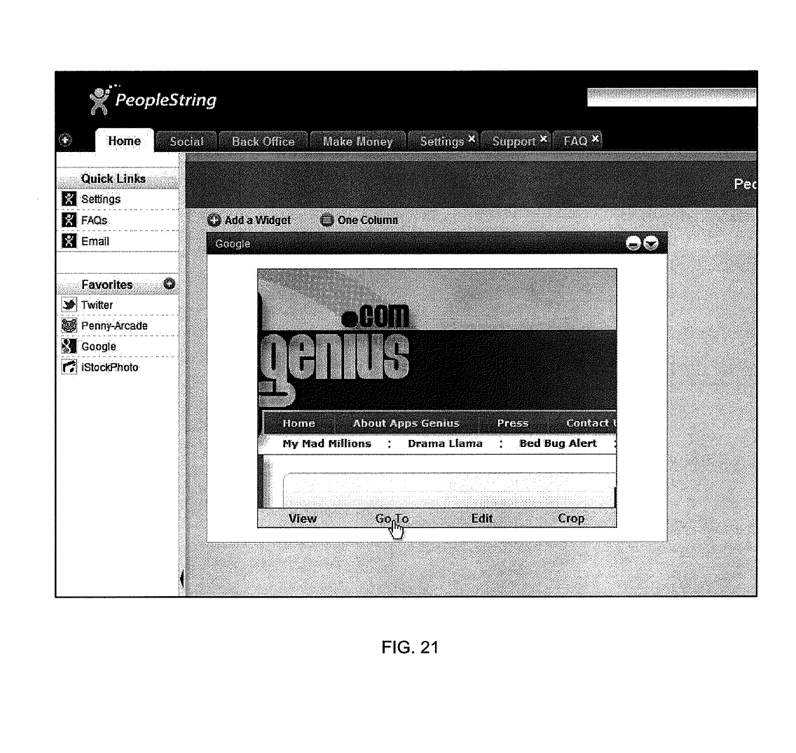

FIG. 21 shows a screen shot wherein the option ‘Go To’ is activated. This opens a window that displays the actual targeted web page.

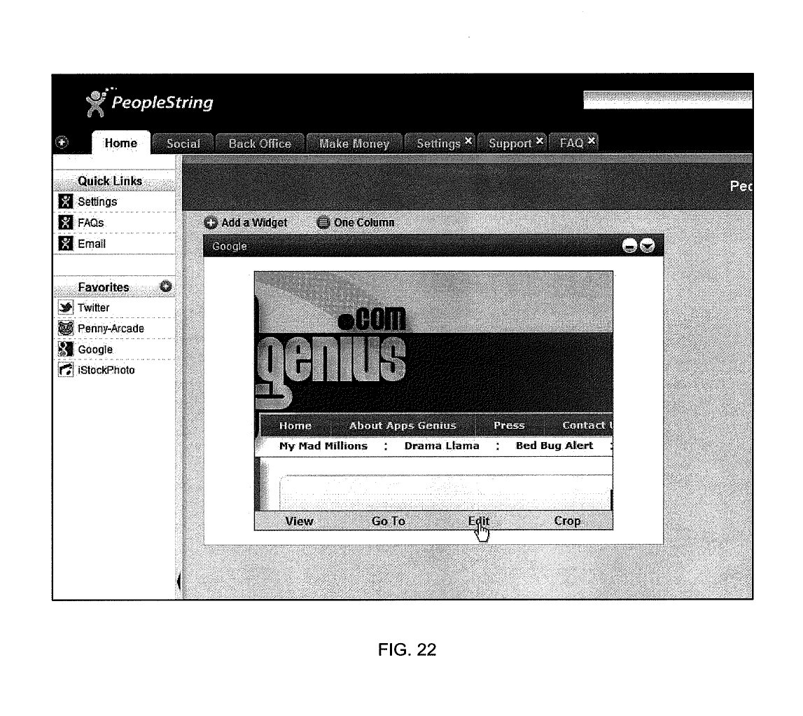

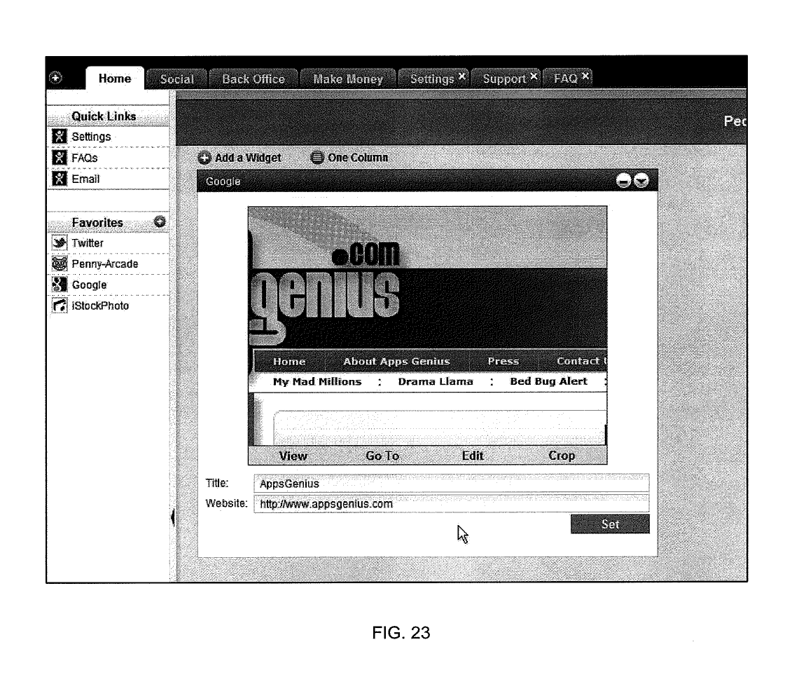

FIG. 22 shows a screen shot wherein the option ‘Edit’ is activated. FIG. 23 shows the Title and Website windows which can be edited. Activating ‘Set’ will save the new settings and returns the focus to the personalized web page.

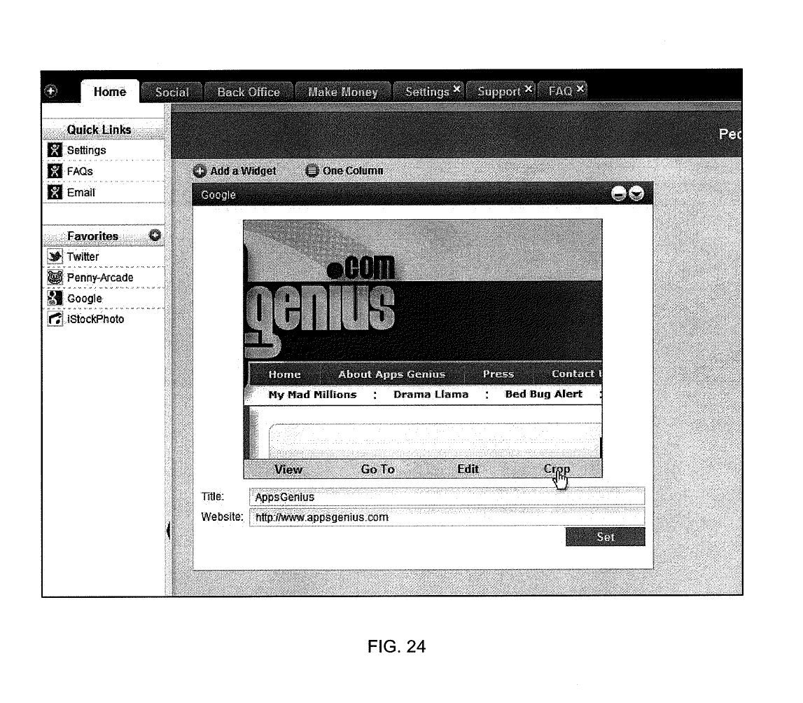

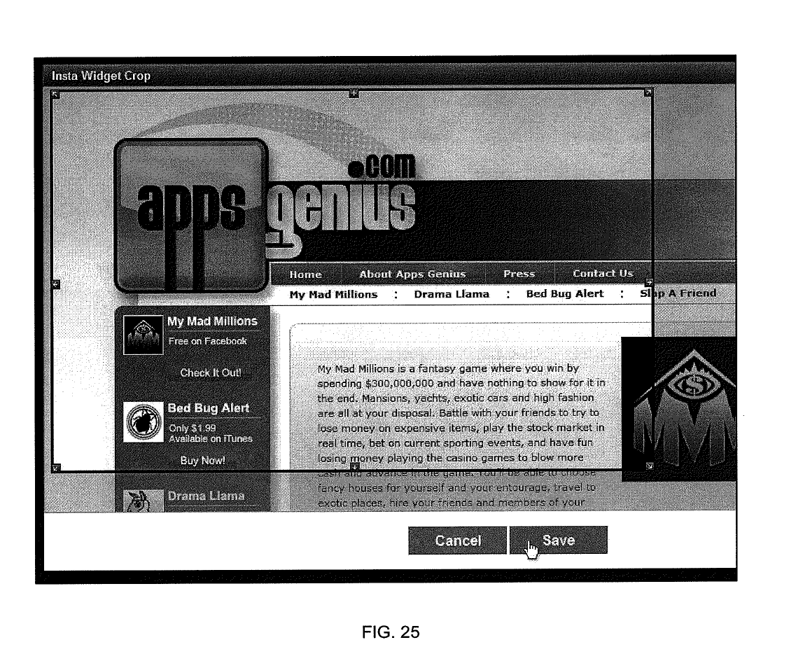

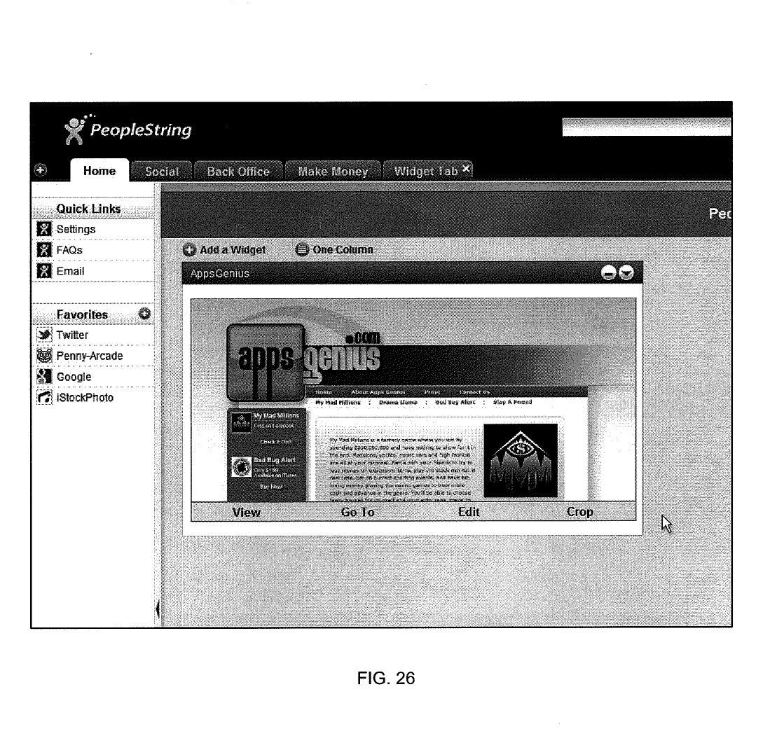

FIG. 24 shows a screen shot wherein the option ‘Crop’ is activated. FIG. 25 shows that as a result the capture or image of the targeted web page is displayed with a cropping window that allows a user to select a different part of the capture or image. Hitting ‘Save’ will store the new settings and return the focus to the operational or display mode with a new view of the targeted web page as is shown in FIG. 26.

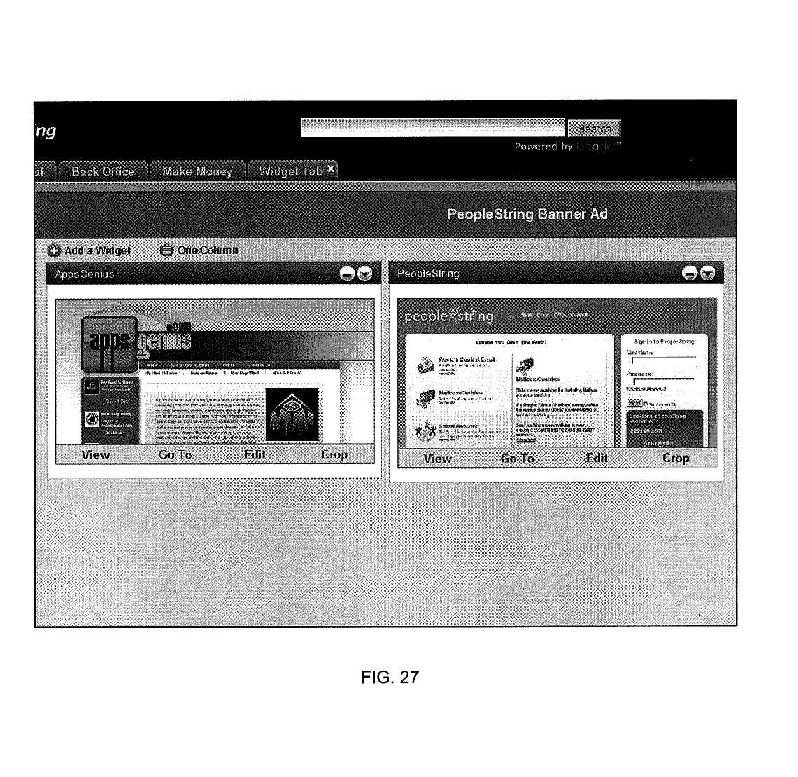

FIG. 27 shows a personalized web page with a first and a second capture or image of a first and a second targeted web page. FIG. 27 illustrates two targeted web pages being displayed on the personalized web page on screen 102 of the computer 101. As previously described, each of the targeted web pages can be cropped. A single targeted web page or more than two targeted web pages can be displayed. In accordance with an aspect of the present invention, the targeted web pages are shown in two columns and over a plurality of rows. These targeted web pages are updated via requests to the server 104, as previously described. The updates can be automatically implemented by periodic requests from the computer 101 to the server 104.

A web page is generally hosted on a server which is a computing device and is downloaded via a network from the server by a computing device for viewing. A web page is generally provided in a coded form which may apply tools such as HTML or variants thereof Cascading Style Sheets (CSS), Javascript, and plug-in applications and the like such as is known in the art. A web page is generally rendered inside a browser residing on the computing device for viewing. The browser uses the coded web page data and the known configuration of the computing device, which may include display properties, to render the web page on a display based on the coded web page data. Coding tools that enable an aspect of the personalized web page and that enable an application residing on the server hosting the personalized web page for obtaining and updating an image of the targeted web page as disclosed herein are known in the art and readily available.

A web page has an address such as a URL or has its formal address hidden in a link or has other ways of being activated. In one embodiment of the present invention a web page is being activated when data that creates a viewable web page inside a browser is being transmitted. Such data often includes HTML code or code like it. In that sense a picture or an image of a web page is different. As described herein, one can take or capture an image of a web page and have the image displayed by a browser. However, as a display of an image of a web page is different from displaying the actual web page. This difference becomes readily apparent if a web page contains links to documents and files such as other web pages. In an image of a web page such links are generally not available. Activating an address of a web page is thus requesting data that will create the web page for viewing inside a browser and that will contain active links to embedded web pages if such links are part of the web page.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims appended hereto.

1. A method for displaying an image of a targeted web page on a personalized web page, comprising:
activating an address of the personalized web page to display the personal web page on a display screen of a computing device;
entering an address of a targeted web page after activating an application;
displaying the image of the targeted web page that is stored on a server;
selecting at least a part of the image of the targeted web page;
displaying the at least part of the image of the targeted web page on the display screen of the computing device as part of the personalized web page; and
automatically updating the image of the targeted web page and the at least part of the image of the targeted web page.

2. The method of claim 1, further comprising:
associating a design of the personalized web page with a user; and
displaying the personalized webpage according to the design on the display of a computing device after the user has signed on to the personalized web page.

3. The method of claim 1, further comprising:
activating an application on the computing device to view the image of the targeted web page without contacting a server that hosts the target web pages.

4. The method of claim 1, further comprising:
enabling a user of the computing device to resize the at least part of the image of the targeted web page that is displayed on the personalized web page.

5. The method of claim 1, wherein an update of the image of the targeted web page takes place automatically on a periodic basis.

6. The method of claim 1, wherein an update of the image of the targeted web page that is displayed on the personalized web page takes place automatically no later than 1 minute after an earlier update.

7. The method of claim 1, wherein revenues generated from displaying the personalized web page are shared with a party associated with the targeted web page.

8. The method of claim 1, wherein the image of the targeted web page on the personalized web page is automatically updated when a user signs on to the personalized web page.

9. The method of claim 1, wherein a party associated with the targeted web page opts in to allow automatic capturing an image of at least part of the targeted web page.

10. A method for viewing a personalized web page by a user of the personalized web page, comprising:
activating on a computing device an address of the personalized web page by the user;
for each of a plurality of targeted web pages previously selected by the user, displaying the personalized web page including an image of at least a first part of each of the plurality of targeted web pages on a display screen of the computing device, wherein each of the images are displayed on a location and with a size inside the personalized web page that has been determined by the user of the personalized web page; and
wherein each of the images on the personalized web page that is displayed on the display screen is updated automatically.

11. The method of claim 10, wherein image of the targeted web page that is displayed on the personalized web page is updated no later than a predetermined amount of time after a previously captured image of the targeted web page was displayed on the display screen.

12. The method of claim 10, further comprising:
visiting the targeted web page for obtaining the automatically updated image of the targeted web page only during a time that the personalized web page is active on the computing device.

13. The method of claim 10, further comprising previewing by the user of the targeted web page on the display of the computing device without visiting a hosting server of the targeted web page.

14. The method of claim 10, further comprising: cropping the image of the targeted web page on the personalized web page.

15. A system for creating a personalized web page, comprising:
a first server, including a memory, data storage, a processor and a connection to an Internet, in communication with a client computing device, the server enabled to execute instructions to perform the steps of:
generating data representing the personalized web page on the client computing device;
saving an image of a targeted web page residing on a second server;
transmitting data representing at least part of the saved image of the targeted web page to the client computing device to display on a display of the computing device as part of the personalized web page;
automatically obtaining and saving an updated image of the targeted web page residing on the second server; and
transmitting data representing at least part of the saved updated image of the targeted web page to display on the display of the computing device as part of the personalized web page.

16. The system of claim 15, wherein the image of the targeted web page is updated automatically at predetermined intervals.

17. The system of claim 15, further comprising the first server enabled to execute instructions to perform the steps of:
crediting a value to a party associated with the targeted web page.

18. The system of claim 15, further comprising the first server enabled to execute instructions to perform the step of:
checking if a party associated with the targeted web page has opted in to allow saving an image related to the targeted web page on the first server.

19. The system of claim 15, further comprising the first server enabled to execute instructions to perform the step of:
checking if a party associated with the targeted web page has opted out of saving an image related to the targeted web page on the first server.

20. The system of claim 15, further comprising the first server enabled to execute instructions to perform the steps of:
automatically updating the image of the targeted web page when the personalized web page is activated.
